(19) United States
(12) Patent Application Publication
(10) Pub. No.: US 2009/0309327 A1
(43) Pub. Date: Dec. 17, 2009

(54) WHEELCHAIR

(75) Inventor: Chih-Yung Huang, Taichung (TW)

Correspondence Address: PEACOCK MYERS, P.C., 201 THIRD STREET, N.W., SUITE 1340, ALBUQUERQUE, NM, 87102, US

(73) Assignee: P & F Brother Industrial Corporation, Taichung (TW)

(21) Appl. No.: 12/243,237

(22) Filed: Oct. 1, 2008

(30) Foreign Application Priority Data
Jun. 17, 2008 (TW) 097122542

(51) Int. Cl. A61G 5/10; B62D 63/00

(52) U.S. Cl. 280/304.1; 280/32.7

(57) ABSTRACT

A wheelchair has a first frame unit including a first wheel unit, a second frame unit including a second wheel unit, and a quick release unit including an axle that is connected rotatably to one of the first and second frame units. The axle is rotatable from a retaining position, where separation of the axle from the other one of the first and second frame units is arrested, to a releasing position, where separation of the axle from the other one of the first and second frame units is permitted. One of the first and second frame units is further provided with a third wheel unit, and the other one of the first and second frame units is further provided with a seat unit.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention

The invention relates to a wheelchair, more particularly to a wheelchair having first and second frame units removably interconnected by a quick release unit.

2. Description of the Related Art

As shown in FIG. 1 a conventional wheelchair 1 includes a front frame unit 11, a rear frame unit 12, and a seat unit 13. The front frame unit 11 includes a front frame member 111, a pair of front wheels 113 (only one is visible) mounted rotatably to a front part of the front frame member 111, and a pair of middle wheels 112 (only one is visible) mounted rotatably to a rear part of the front frame member 111. The rear frame unit 12 includes a rear frame member 121, and a pair of rear wheels 122 (only one is visible) mounted rotatably to a rear part of the rear frame member 121. The rear frame unit 12 further includes a pivot axle 123 that extends rotatably through the front frame member 111 and the rear frame member 121, such that the front frame unit 11 is pivotable about the pivot axle 123 relative to the rear frame unit 12, such that the middle wheels 112 are disposed between the front and rear wheels 113, 122, and such that the conventional wheelchair 1 can move smoothly on an uneven ground. Moreover, the front and rear frame units 11, 12 can be disassembled from each other by removing the pivot axle 123 so as to facilitate packaging and transport of the conventional wheelchair 1, and can be reassembled by using the pivot axle 123 to interconnect the front and rear frame members 111, 121.

However, the abovementioned disassembling and assembling procedures are relatively time consuming and inconvenient.

### SUMMARY OF THE INVENTION

Therefore, the object of the present invention is to provide a wheelchair having first and second frame units removably interconnected by a quick release unit.

Accordingly, a wheelchair of the present invention comprises a first frame unit, a second frame unit, and a quick release unit. The first frame unit includes a first frame member, and a first wheel unit provided rotatably on the first frame member and having a first wheel axis. The second frame unit includes a second frame member, and a second wheel unit provided rotatably on the second frame member and having a second wheel axis parallel to the first wheel axis. The quick release unit is for interconnecting removably the first and second frame members such that the first and second frame members are pivotable relative to each other about a pivot axis parallel to the first and second wheel axes. The quick release unit includes an axle that defines the pivot axis and that is connected rotatably to one of the first and second frame members, and at least one engaging mechanism for retaining removably the axle on the other one of the first and second frame members. The engaging mechanism includes a first engaging portion formed on the axle and disposed radially relative to the pivot axis, and a second engaging portion mounted on the other one of the first and second frame members and defining an engaging groove for receiving the first engaging portion. The axle is rotatable relative to the second engaging portion from a retaining position, where the first engaging portion is received in the engaging groove and cooperates with the second engaging portion to arrest separation of the axle from the other one of the first and second frame members in a first direction transverse to the pivot axis, to a releasing position, where the first engaging portion is removed from the engaging groove to permit separation of the axle from the other one of the first and second frame members in the first direction. One of the first and second frame members is further provided with a third wheel unit that is rotatable about a third wheel axis parallel to and located between the first and second wheel axes, and the other one of the first and second frame members is further provided with a seat unit.

### BRIEF DESCRIPTION OF THE DRAWINGS

Other features and advantages of the present invention will become apparent in the following detailed description of the preferred embodiments with reference to the accompanying drawings, of which:

FIG. 1 is a side view of a conventional wheelchair;

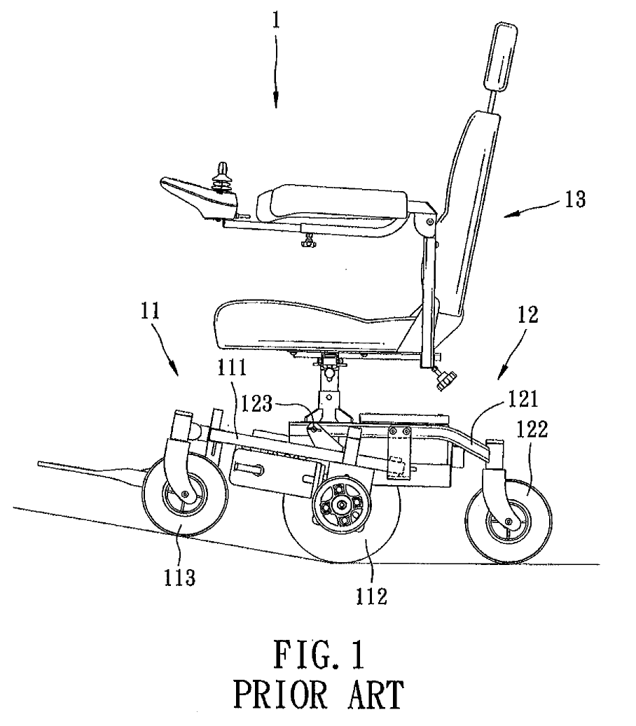

FIG. 2 is a top view of a preferred embodiment of a wheelchair according to the invention;

FIG. 3 is a fragmentary perspective view of the preferred embodiment, illustrating a quick release unit thereof;

FIG. 4 is a fragmentary side view of the preferred embodiment, illustrating an axle of the quick release unit at a retaining position;

FIG. 5 is an enlarged fragmentary sectional view of the preferred embodiment, illustrating an engaging mechanism thereof;

FIG. 6 is a view similar to FIG. 4, but illustrating the axle at a releasing position; and

FIG. 7 is a fragmentary exploded side view of the preferred embodiment.

### DETAILED DESCRIPTION OF THE PREFERRED EMBODIMENT

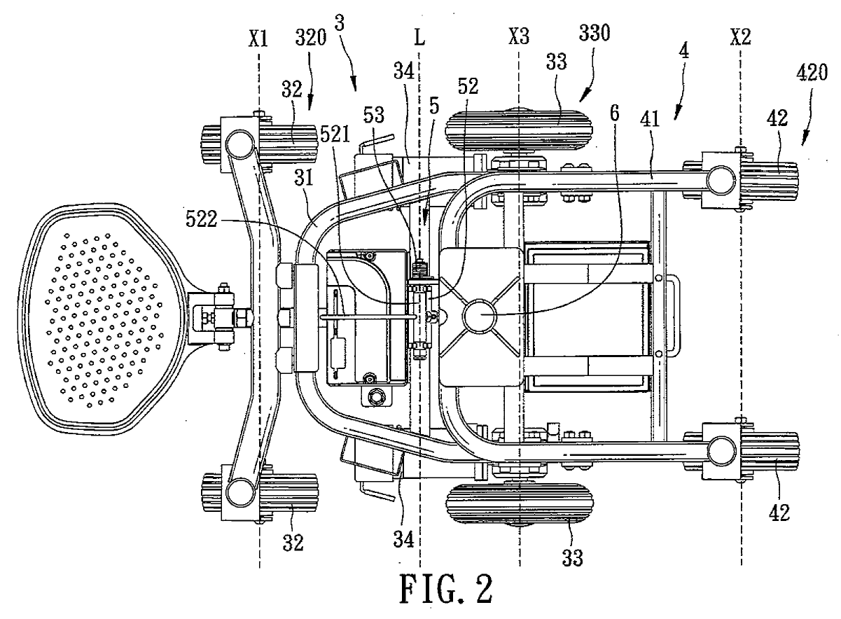

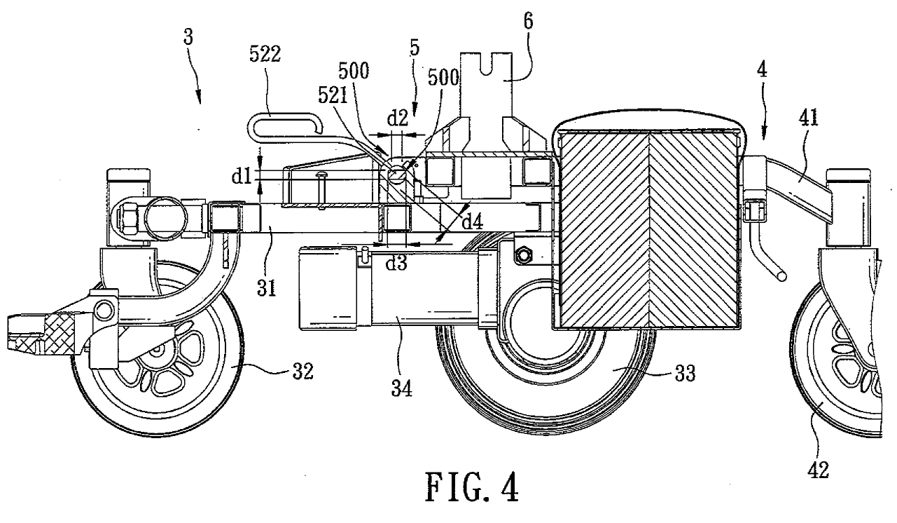

As shown in FIGS. 2 to 4, the preferred embodiment of a wheelchair according to the present invention comprises a first frame unit 3, a second frame unit 4, a quick release unit 5, and a seat unit 6.

The first frame unit 3 includes a first frame member 31, and a first wheel unit 320 provided rotatably on the first frame member 31 and having a first wheel axis (X1). The first wheel unit 320 includes a pair of first wheels 32. The second frame unit 4 includes a second frame member 41, and a second wheel unit 420 provided rotatably on the second frame member 41 and having a second wheel axis (X2) parallel to the first wheel axis (X1). The second wheel unit 420 includes a pair of second wheels 42. In this embodiment, the first frame member 31 is further provided with a third wheel unit 330 rotatable about a third wheel axis (X3) parallel to and located between the first and second wheel axes (X1, X2). The third wheel unit 330 includes a pair of third wheels 33. In this embodiment, the first frame member 31 is further provided with a pair of motors 34 for driving rotation of the third wheels 33, respectively.

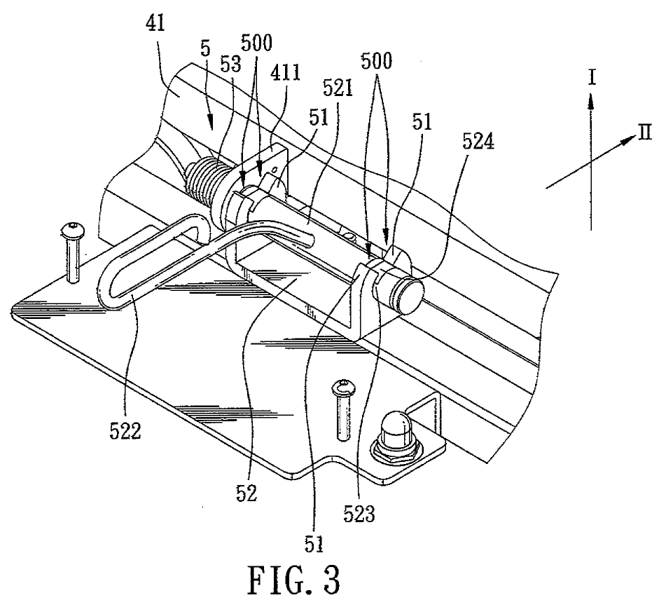

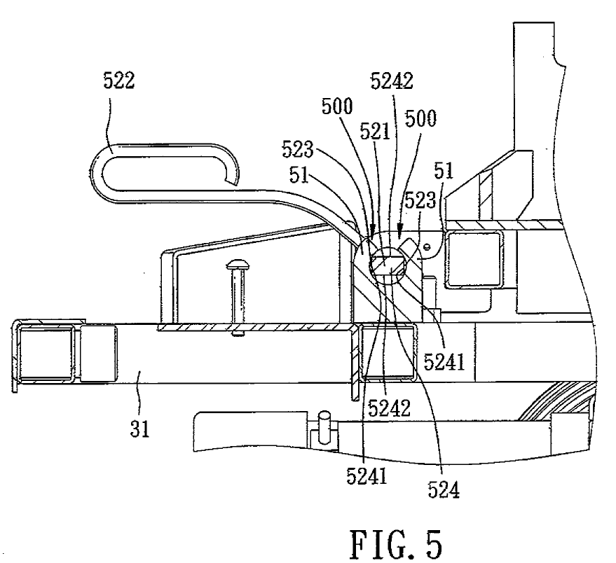

Referring to FIGS. 3 to 6, the quick release unit 5 is disposed for interconnecting removably the first and second frame members 31, 41 such that the first and second frame members 31, 41 are pivotable relative to each other about a pivot axis (L) parallel to the first and second wheel axes (X1, X2). In this embodiment, the quick release unit 5 has four engaging mechanisms 500 for arresting and permitting separation of the second frame unit 4 from the first frame unit 3 in a first direction (I) transverse to the pivot axis (L), and includes an axle 521 and a support seat 52.

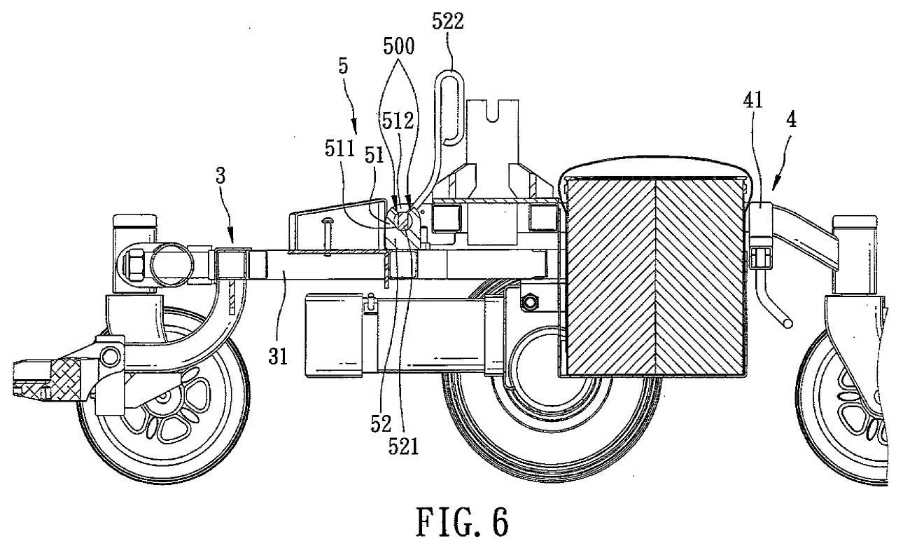

The axle 521 defines the pivot axis (L), is connected rotatably to a connecting plate 411 that projects from the second frame member 41 of the second frame unit 4 in a second direction (II) transverse to the pivot axis (L) and the first direction (I), and is connected rotatably to the first frame member 31 of the first frame unit 3. Each of the engaging mechanisms 500 is disposed for retaining removably the axle 521 on the first frame member 31, and includes a first engaging portion 523 formed on the axle 521 and disposed radially relative to the pivot axis (L), and a second engaging portion 51 mounted on the first frame member 31 and defining an engaging groove 511 for receiving the first engaging portion 523. The support seat 52 is a U-shaped plate mounted on the first frame member 31, and has opposite end parts in a direction parallel to the pivot axis (L). Each of the end parts of the support seat 52 is configured with a pair of second engaging portions 51 having distal ends that are spaced apart from each other in the second direction (II), that define respectively the engaging grooves 511, and that cooperatively define a notch 512. The notch 512 has a width (d2) in the second direction (II) that is narrower than a distance (d4) in the second direction (II) between groove bottoms of the engaging grooves 511. In this embodiment, the axle 521 has opposite ends along the pivot axis (L), each of which has a root part 524 with diametrically opposite first sides 5241 and diametrically opposite second sides 5242 extending between the first sides 5241. The first engaging portions 523 of two of the engaging mechanisms 500 extend respectively from the first sides 5241 of the root part 524 at one end of the axle 521, while the first engaging portions 523 of the other two of the engaging mechanisms 500 extend respectively from the first sides 5241 of the root part 524 at the other one end of the axle 521. In this embodiment, a distance (d1) between the second sides 5242 of the root part 524 at a respective one of the ends of the axle 521 is shorter than the width (d2) of the notch 512 in the corresponding one of the end parts of the support seat 52, and a distance (d3) between tips of the first engaging portions 523 at a respective one of the ends of the axle 521 is larger than the width (d2) of the notch 512 in the corresponding one of the end parts of the support seat 52 and shorter than the distance (d4) between the groove bottoms of the engaging grooves 511 of the second engaging portions in the corresponding one of the end parts of the support seat 52. The axle 521 is rotatable relative to the second engaging portions 51 of the engaging mechanisms 500 from a retaining position (see FIGS. 3 to 5), where the first engaging portions 523 at a respective one of the ends of the axle 521 are received respectively in the engaging grooves 511 of the second engaging portions 51 at the corresponding one of the end parts of the support seat 52, i.e., the second engaging portions 51 at the corresponding one of the end parts of the support seat 52 are disposed on diametrically opposite sides of the axle 521, and cooperate with the second engaging portions 51 at the corresponding one of the end parts of the support seat 52 to arrest separation of the axle 521 from the first frame member 31 in the first direction (I), to a releasing position (see FIG. 6), where the first engaging portions 523 at a respective one of the ends of the axle 521 are removed respectively from the engaging grooves 511 of the second engaging portions 51 at the corresponding one of the end parts of the support seat 52 to permit separation of the axle 521 from the first frame member 31 in the first direction (I).

The quick release unit 5 further includes a torsion spring 53 interconnecting the axle 521 and the second frame member 41 of the second frame unit 4 for biasing the axle 521 to the retaining position relative to the second engaging portions 51 of the engaging mechanisms 500, and a handle 522 projecting radially and outwardly from the axle 521 for driving rotation of the axle 521 between the retaining position and the releasing position.

The seat unit 6 is provided on the second frame member 41 of the second frame unit 4 between the second wheel unit 420 and the axle 521.

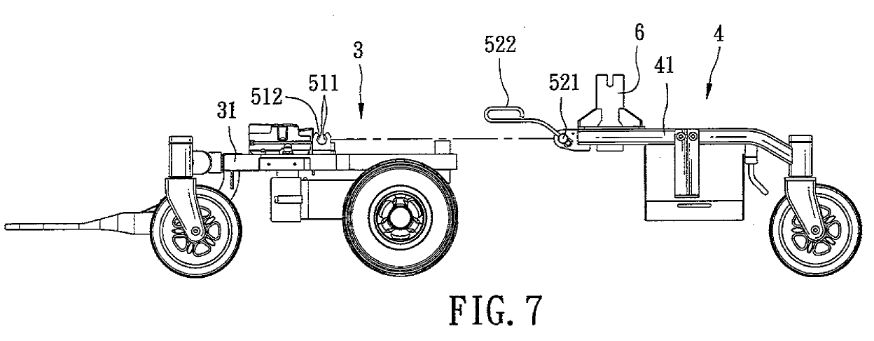

When the wheelchair of this embodiment is in use, the axle 521 of the quick release unit 5 is biased by the torsion spring 53 of the quick release unit 5 to the retaining position, such that the first frame unit 3 is pivotable about the axle 521 of the quick release unit 5 relative to the second frame unit 4 so that the wheelchair of this embodiment can move smoothly on an uneven ground. Moreover, as shown in FIGS. 6 and 7, the first and second frame units 3 and 4 can be disassembled from each other by operating the handle 522 to drive rotation of the axle 521 of the quick release unit 5 relative to the second engaging portions 51 of the engaging mechanisms 500 from the retaining position to the releasing position and removing the axle 521 from the second engaging portions 51 of the support seat 52 via the notches 512, and can be reassembled by placing the axle 521 back in the second engaging portions 51 via the notches 512 and moving the handle 522 to the retaining position. Therefore, the wheelchair of this embodiment has simpler disassembling and assembling procedures than the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wheelchair comprising:
a first frame unit including a first frame member, and a first wheel unit provided rotatably on said first frame member and having a first wheel axis;
a second frame unit including a second frame member, and a second wheel unit provided rotatably on said second frame member and having a second wheel axis parallel to the first wheel axis; and
a quick release unit for interconnecting removably said first and second frame members such that said first and second frame members are pivotable relative to each other about a pivot axis parallel to the first and second wheel axes, said quick release unit including:
an axle that defines the pivot axis and that is connected rotatably to one of said first and second frame members, and
at least one engaging mechanism for retaining removably said axle on the other one of said first and second frame members, said engaging mechanism including a first engaging portion formed on said axle and disposed radially relative to the pivot axis, and a second engaging portion mounted on the other one of said first and second frame members and defining an engaging groove for receiving said first engaging portion, said axle being rotatable relative to said second engaging portion from a retaining position, where said first engaging portion is received in said engaging groove and cooperates with said second engaging portion to arrest separation of said axle from the other one of said first and second frame members in a first direction transverse to the pivot axis, to a releasing position, where said first engaging portion is removed from said engaging groove to permit separation of said axle from the other one of said first and second frame members in the first direction;
wherein one of said first and second frame members is further provided with a third wheel unit that is rotatable about a third wheel axis parallel to and located between the first and second wheel axes, and the other one of said first and second frame members is further provided with a seat unit.

2. The wheelchair as claimed in claim 1, wherein said quick release unit includes two of said engaging mechanisms, said second engaging portions of said engaging mechanisms being disposed on diametrically opposite sides of said axle when said axle is at the retaining position, said second engaging portions having distal ends that are spaced apart from each other in a second direction transverse to the pivot axis and the first direction and that cooperatively define a notch, said notch having a width in the second direction that is narrower than a distance in the second direction between groove bottoms of said engaging grooves of said second engaging portions.

3. The wheelchair as claimed in claim 2, wherein said axle has a root part with diametrically opposite first sides and diametrically opposite second sides extending between said first sides, said first engaging portions of said engaging mechanisms extending respectively from said first sides of said root part, a distance between said second sides of said root part being shorter than the width of said notch, a distance between tips of said first engaging portions of said engaging mechanisms being larger than the width of said notch and shorter than the distance between said groove bottoms of said engaging grooves of said second engaging portions.

4. The wheelchair as claimed in claim 1, wherein said quick release unit further includes a torsion spring interconnecting said axle and said one of said first and second frame members for biasing said axle to the retaining position relative to said second engaging portion.

5. The wheelchair as claimed in claim 1, wherein said quick release unit further includes a handle projecting radially and outwardly from said axle for driving rotation of said axle between the retaining position and the releasing position.

6. The wheelchair as claimed in claim 1, wherein said one of said first and second frame members is further provided with a motor unit for driving rotation of said third wheel unit.
